(19) United States
(12) Patent Application Publication
(10) Pub. No.: US 2022/0141341 A1
(43) Pub. Date: May 5, 2022

(54) CONFERENCE TERMINAL AND MULTI-DEVICE COORDINATING METHOD FOR CONFERENCE

(71) Applicant: Acer Incorporated, New Taipei City (TW)

(72) Inventors: Po-Jen Tu, New Taipei City (TW); Jia-Ren Chang, New Taipei City (TW); Kai-Meng Tzeng, New Taipei City (TW); Chao-Kuang Yang, New Taipei City (TW)

(73) Assignee: Acer Incorporated, New Taipei City (TW)

(21) Appl. No.: 17/143,172

(22) Filed: Jan. 7, 2021

(30) Foreign Application Priority Data
Nov. 5, 2020 (TW) 109138512

(51) Int. Cl. H04M 3/56

(52) U.S. Cl. CPC H04M 3/568; H04M 3/562

(57) ABSTRACT

A conference terminal and a multi-device coordinating method for the conference are provided. In the method, multiple conference terminals are allocated to a plurality of areas according to location relationship. Each area includes one or more conference terminals that are close in the location relationship. An input sound signal is obtained from picking up a sound by the conference terminal in each area. The input sound signal of the one or more conference terminals in a first area among the areas is allocated to the one or more conference terminals in a second area among the areas to be played. The input sound signal obtained from picking up the sound by the conference terminal in each area is not played by any conference terminal in the same area.

### CROSS-REFERENCE TO RELATED APPLICATION

This application claims the priority benefit of Taiwanese application no. 109138512, filed on Nov. 5, 2020. The entirety of the above-mentioned patent application is hereby incorporated by reference herein and made a part of this specification.

### BACKGROUND

### Technical Field

The disclosure relates to a voice conference; particularly, the disclosure relates to a conference terminal and a multi-device coordinating method for a conference.

### Description of Related Art

Remote conferences allow people in different locations or spaces to make conversations, and conference-related equipment, protocols, and/or applications are also well developed. Notably, in actual cases, people may participate in a telephone or video conference in the same space using their own communication devices, respectively. During communication between these communication devices at the same time, microphones on the devices pick up sounds from speakers of several other devices, forming many unstable feedback mechanisms, causing obvious whistling sounds, and thereby affecting the conference procedure.

### SUMMARY

The embodiment of the disclosure provides a conference terminal and a multi-device coordinating method for a conference, so that a plurality of devices participate in a conference call in the same space at the same time without interference.

The multi-device coordinating method for a conference according to an embodiment of the disclosure is adapted for a plurality of conference terminals. Each conference terminal includes a sound receiver and a loudspeaker. The multi-device coordinating method includes (but is not limited to) the following steps. The conference terminals are allocated to a plurality of areas according to location relationship. Each area includes one or more conference terminals that are close in the location relationship. An input sound signal is obtained from picking up or recording a sound by the conference terminal in each area. The input sound signal of the one or more conference terminals in a first area among the areas is allocated to the one or more conference terminals in a second area among the areas to be played. The input sound signal obtained from picking up the sound by the conference terminal in each area is not played by any of the conference terminal in the same area.

The conference terminal according to an embodiment of the disclosure includes (but is not limited to) a sound receiver, a loudspeaker, a communication transceiver, and a processor. The sound receiver is configured to pick up or record a sound in order to obtain an input sound signal. The loudspeaker is configured to play a sound. The communication transceiver is configured to send or receive data. The processor is coupled to the sound receiver, the loudspeaker, and the communication transceiver. The processor is configured to determine to belong to a first area of a plurality of areas according to location relationship, send the input sound signal through the communication transceiver, and play the input sound signal of the conference terminal in a second area of the areas through the loudspeaker. The first area is different from the second area. The input sound signal obtained from picking up the sound by one or more conference terminals in each area is not played by the loudspeaker of any conference terminal in the same area.

Based on the foregoing, in the conference terminal and the multi-device coordinating method for a conference according to the embodiment of the disclosure, the area to which the conference terminal belongs is determined based on the location of the conference terminal, and the sound signal from one area is allocated as the sound signal to be played in other areas. This prevents cross-interference between sounds or whistling.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an architecture of a conference system according to an embodiment of the disclosure.

FIG. 2 is a flowchart of a multi-device coordinating method for a conference according to an embodiment of the disclosure.

FIG. 3 is a schematic flowchart of individual sound signal separation according to an embodiment of the disclosure.

### DESCRIPTION OF THE EMBODIMENTS

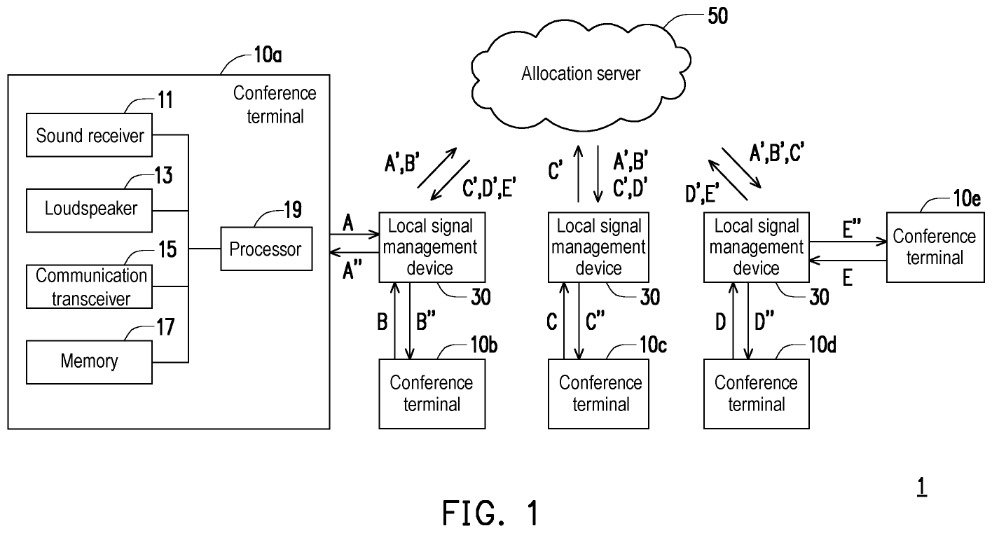

FIG. 1 is a schematic diagram of an architecture of a conference system 1 according to an embodiment of the disclosure. With reference to FIG. 1, the conference system 1 includes (but is not limited to) a plurality of conference terminals 10a-10e, a plurality of local signal management devices 30, and an allocation server 50.

The conference terminals 10a-10e may each be a wired phone, a mobile phone, a tablet computer, a desktop computer, a notebook computer, or a smart speaker. The conference terminals 10a-10e each include (but is not limited to) a sound receiver 11, a loudspeaker 13, a communication transceiver 15, memory 17, and a processor 19.

The sound receiver 11 may be a microphone in any form, such as dynamic, condenser, electret condenser, or the like. The sound receiver 11 may also be a combination of an electronic element, an analog-to-digital converter, a filter, and an audio processor that receives a sound wave (e.g., a human voice, an environmental sound, a machine operation sound, etc.) and converts the sound wave into a sound signal. In an embodiment, the sound receiver 11 is configured to pick up or record a sound of a speaking person to obtain an input sound signal. The input sound signal may include a voice of the speaking person, a sound of the loudspeaker 13, and/or other environmental sounds.

The loudspeaker 13 may be a speaker or an amplifier. In an embodiment, the loudspeaker 13 is configured to play a sound.

The communication transceiver 15 is, for example, a transceiver (including but not limited to a connection interface, a signal converter, a communication protocol processing chip, and other elements) that supports Ethernet, optical fiber networks, cables, or other wired networks, and it may as well be a transceiver (including but not limited to an antenna, a digital-to-analog/analog-to-digital converter, a communication protocol processing chip, and other elements) that supports Wi-Fi, fourth generation (4G), fifth generation (5G), later generation mobile networks, or other wireless networks. In an embodiment, the communication transceiver 15 is configured to send or receive data.

The memory 17 may include a fixed or removable element in any form, such as a random access memory (RAM) device, a read only memory (ROM) device, a flash memory device, a traditional hard disk drive (HDD), a solid-state drive (SSD), or the like. In an embodiment, the memory 17 is configured to record codes, software modules, configurations, data (e.g., a sound signal, an area list, or the like), or files.

The processor 19 is coupled to the sound receiver 11, the loudspeaker 13, the communication transceiver 15, and the memory 17. The processor 19 may include a central processing unit (CPU), a graphic processing unit (GPU), or any other programmable general-purpose or special-purpose microprocessor, digital signal processor (DSP), programmable controller, field programmable gate array (FPGA), application-specific integrated circuit (ASIC), other similar elements, or a combination of the above elements. In an embodiment, the processor 19 is configured to execute all or some operations of the conference terminals 10a-10e to which the processor 19 belongs, and may load and execute the software modules, files, and data recorded in the memory 17.

The local signal management devices 30 are connected to the conference terminals 10a-10e. The local signal management devices 30 may be a computer system, a server, or a signal processing device. In an embodiment, the conference terminals 10a-10e may serve as the local signal management devices 30. In another embodiment, the local signal management devices 30 may be an independent relay device different to the conference terminals 10a-10e. In some embodiments, the local signal management devices 30 each include (but is not limited to) the same or similar communication transceiver 15, memory 17, and processor 19, and the implementation and function of the elements will not be repeatedly described.

The allocation server 50 is connected to the local signal management devices 30. The allocation server 50 may be a computer system, a server, or a signal processing device. In an embodiment, the conference terminals 10a-10e or the local signal management devices 30 may serve as the allocation server 50. In another embodiment, the allocation server 50 may be an independent cloud server different to the conference terminals 10a-10e or the local signal management devices 30. In some embodiments, the allocation server 50 includes (but is not limited to) the same or similar communication transceiver 15, memory 17, and processor 19, and the implementation and function of the elements will not be repeatedly described.

Hereinafter, a method according to an embodiment of the disclosure will be explained accompanied with the various devices, elements, and modules in the conference system 1. Depending on the implementation condition, each procedure of the method may be accordingly adjusted, and is not limited thereto.

In addition, it should be noted that, for the convenience of description, the same element may realize the same or similar operation, and will not be repeatedly described. For example, since the conference terminals 10a-10e may serve as the local signal management devices 30 or the allocation server 50, and the local signal management devices 30 may also serve as the allocation server 50, in some embodiments, therefore, the processors 19 of the conference terminals 10a-10e, the local signal management devices 30, and the allocation server 50 may each realize the same or similar method according to the embodiment of the disclosure.

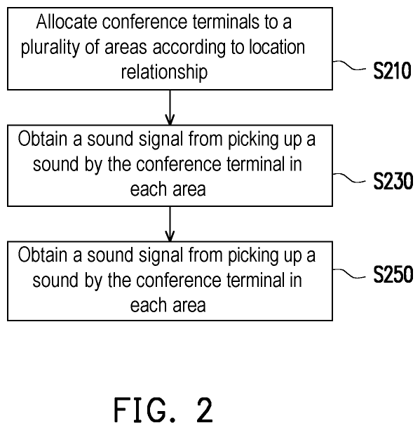

FIG. 2 is a flowchart of a multi-device coordinating method for a conference according to an embodiment of the disclosure. With reference to FIG. 1, the processor 19 allocates the conference terminals 10a-10e to a plurality of areas according to location relationship (S210). Specifically, each area may correspond to a specific space, range, compartment, or floor. Besides, each area includes one or more conference terminals 10a-10e that are close in the location relationship (e.g., within a certain distance, in the same space, on the same floor, or the like). For example, in FIG. 1, the processor 19 of the conference terminals 10a-10e located on the leftmost of the figure may be determined to belong to one of the areas according to the location relationship. In addition, the conference terminals 10a-10e located on the rightmost of the figure belong to another of the areas.

In an embodiment, the conference terminals 10a-10e may determine on their own the area to which they belong. For example, a user interface provides area options related to conference room numbers for the speaking person to select from. In another embodiment, each local signal management device 30 serves as a representative of one area, and determines whether the adjacent conference terminals 10a-10e belong to the same area according to a relative distance between the conference terminals 10a-10e. For example, in FIG. 1, the two conference terminals 10a and 10b on the left belong to the same area as the leftmost local signal management device 30. Besides, the conference terminals 10a-10e that belong to the same area may be connected to the local signal management device 30 through the communication transceiver 15.

The processor 19 of each of the conference terminals 10a-10e may pick up the sound through the sound receiver 11 to obtain the respective input sound signal. For example, with a conference established through video software, voice call software, or a phone call, the speaking person may then start talking. The processor 19 may send the input sound signal through the communication transceiver 15 to the local signal management device 30 in the same area via the network. Namely, in each area, the local signal management device 30 obtains the input sound signals from picking up the sounds by the conference terminals 10a-10e in the area (S230).

In an embodiment, one of the conference terminals 10a-10e serves as the local signal management device 30 (as a master). The master may provide an application that integrates the input sound signals of the sound receivers 11 and output sound signals of the loudspeakers 13 from all of the conference terminals 10a-10e in the same area. One conference terminal (taking the conference terminal 10a as an example) in this area is selected as the master and the other conference terminals (taking the conference terminal 10b as an example) as a slave. Through virtual audio cable (VAC) technology (i.e., forwarding audio streams), the application extracts the signal of each conference terminal (taking conference terminals 10a and 10b as an example), and then send the signal to the master.

In an embodiment, the processor 19 of the local signal management device 30 or the conference terminals 10a-10e serving as the master may separate, from the input sound signal, an individual sound signal recorded from the speaking person corresponding to each of the conference terminals 10a-10e in the same area. Specifically, it may be inevitable that not only the voices of the speaking persons (assumed to be located directly in front of the conference terminals 10a-10e) using the conference terminals 10a-10e are picked up or recorded by the sound receiver 11, but other interference such as the sound of each loudspeaker 13 in the same area, the environmental noise on site, etc. is also picked up by the same sound receiver 11. For example, the sound receiver 11 of the conference terminal 10a in FIG. 1 picks up the sounds recorded from its corresponding loudspeaker 13 and the loudspeaker 13 of the conference terminal 10b. The additional sounds (i.e., the sounds other than the voice of the speaking person) may each cause whistling sounds during the call. In the embodiment of the disclosure, the voice of one of the speaking persons is separated according to other input sound signals and/or the output sound signals of some or all of the loudspeaker 13.

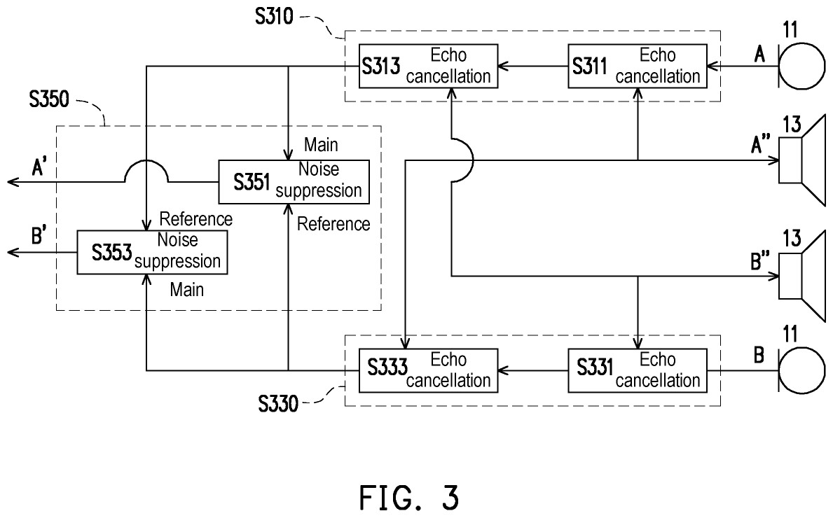

FIG. 3 is a schematic flowchart of individual sound signal separation according to an embodiment of the disclosure. With reference to FIG. 3, the area of the conference terminal 10a and 10b is taken as an example, and the rest may be understood by analogy. In an embodiment, the processor 19 of the local signal management device 30 or the conference terminal 10a serving as the master may cancel an echo in the input sound signal picked up by the sound receiver 11 of one of the conference terminals according to the output sound signal played by the loudspeaker 13 of all or some of the conference terminals 10a and 10b in the area thereof (S310). The echo cancellation technology includes, for example, various kinds of adaptive filtering algorithms. Taking the conference terminal 10a of FIG. 1 as an example, the processor 19 may cancel an echo in an input sound signal A according to an output sound signal A″ (with shorter delay) of the corresponding loudspeaker 13 (S311), and cancel the echo in the input sound signal A according to an output sound signal B″ (with slightly longer delay) of another loudspeaker 13 (belonging to the conference terminal 10b) (S313). Similarly, in echo cancellation for the conference terminal 10b (S330), the processor 19 thereof may cancel an echo in an input sound signal B according to the output sound signal B″ of the corresponding loudspeaker 13 (S331), and cancel the echo in the input sound signal B according to the output sound signal A″ of another loudspeaker 13 (belonging to the conference terminal 10a) (S333).

Notably, in the echo cancellation technology, a relative distance between the sound source and the sound receiver 11 (related to the delay) requires to be taken into consideration. Since the conference terminals 10a and 10b or the speaking person may move, dynamic adjustment is required for the corresponding delay.

In an embodiment, the processor 19 of the local signal management device 30 or the conference terminal 10a serving as the master may separate the individual sound signal recorded from the speaking person corresponding to another conference terminal in the same area with the input sound signal of one of the conference terminals in the area serving as reference noise (S350). For example, the processor 19 may cancel noise (i.e., cancel the input sound signal B as the noise) from the input sound signal A (possibly after the echo cancellation in S310) with noise suppression (noise reduction or sound source separation) technology (e.g., generate a signal with an opposite phase to the noise sound wave, or utilizing independent components analysis (ICA), or the like) with the input sound signal B of the conference terminal 10b (possibly after the echo cancellation in S330) serving as the noise (S351), to accordingly output an individual sound signal A′ recorded from the speaking person speaking toward the conference terminal 10a. Similarly, the processor 19 may cancel noise (i.e., cancel the input sound signal A as the noise) from the input sound signal B (possibly after the echo cancellation in S330) with noise suppression technology with the input sound signal A of the conference terminal 10a (possibly after the echo cancellation in S310) serving as the noise (S353), to accordingly output an individual sound signal B′ recorded from the speaking person speaking toward the conference terminal 10b.

Notably, by analogy, input sound signals C, D, and E may be processed to accordingly separate individual sound signals C′, D′, and E′ of speaking persons, which will not be repeatedly described here. In this way, cross-interference or whistling from other areas can be avoided.

The local signal management device 30 in each area may send the input sound signal (it is possible that only one conference terminal is present in the same area, and only the echo cancellation is required) or the individual sound signals A′-E′ that are processed (it is possible that the plurality of conference terminals 10a-10e are present in the same area) to the allocation server 50 via the network. The processor 19 of the allocation server 50 may allocate the input sound signals of the conference terminals 10a-10e in one of the areas to the conference terminals 10a-10e in another of the areas to be played (S250). Specifically, in order to prevent cross-interference of the sounds or whistling in the same area, the input sound signals A-E obtained from picking up the sounds by the conference terminals 10a-10e in each area or the individual sound signals A′-E′ are not played by the loudspeaker 13 of any of the conference terminals 10a-10e in the same area.

Taking Table (1) as an example, assuming that the conference terminals 10a and 10b are in a first area, the conference terminal 10c is in a second area, and the conference terminals 10d and 10e are in a third area.

TABLE 1

| | A′ | B′ | C′ | D′ | E′ |
|---|---|---|---|---|---|
| First area | Tx | Tx | Rx | Rx | Rx |
| Second area | Rx | Rx | Tx | Rx | Rx |
| Third area | Rx | Rx | Rx | Tx | Tx |

Herein, Tx represents the sound signal that is sent, and is accordingly sent to the allocation server 50 or other communication software for integration. Besides, Rx represents the sound signal that is received, and is accordingly sent to the conference terminals 10a-10e and/or the local signal management devices 30. For example, the local signal management device 30 of the first area sends the individual sound signals A′ and B′ to the allocation server 50, but only receives the individual sound signals C′, D′, and E′. The rest may be understood by analogy, and will not be repeatedly described herein. Namely, the individual sound signals A′-E′ of each speaking person are allocated to other conference terminals 10a-10e in different areas to be played (i.e., as the output sound signals A″-E″ of each of the loudspeakers 13).

Through the communication transceiver 15, the processors 19 of the conference terminals 10a-10e may be forwarded from the local signal management devices 30 with, or directly receive the input sound signal or the individual sound signal that is allocated. In an embodiment, the processors 19 of the conference terminals 10a-10e may synthesize the individual sound signals or the input sound signals of all or some of the conference terminals 10a-10e in other areas, to be played by the conference terminals 10a-10e in one of the areas (different from any of the above-mentioned other areas). For example, the conference terminal 10a may select any one or more of the individual sound signals C′, D′, and E′ for synthesis, and play a synthesized sound signal (i.e., the output sound signal A″ including the individual sound signals C′, D′, and E′) through the loudspeaker 13.

In some embodiments, each of the conference terminals 10a-10e is only allocated with one of the individual sound signals A′-E′ from other areas.

In summary of the foregoing, in the conference terminal and the multi-device coordinating method for a conference according to the embodiment of the disclosure, the conference terminals are allocated to appropriate areas, the signals are distributed by areas (e.g., sending the input sound signal in the same area and receiving only the input sound signal from other areas), sound source separation is performed on the input sound signals that are obtained from picking up the sounds, and the sounds from the conference terminals are synthesized before being played. In this way, during the conference of multiple devices in multiple spaces at the same time, cross-interference of the sounds or whistling in the same area or from different areas can be prevented.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A multi-device coordinating method for a conference, the method being adapted for a plurality of conference terminals, the conference terminals each comprising a sound receiver and a loudspeaker, wherein the multi-device coordinating method comprises:
allocating the conference terminals to a plurality of areas according to location relationship, wherein each of the areas comprises at least one conference terminal that is close in the location relationship;
obtaining input sound signals from picking up a sound by the conference terminals in each of the areas, comprises:
determining a representative of one of the plurality of areas from the conference terminals;
obtaining, by the representative, the input sound signals in one of the plurality of areas;
determining an allocation server from the conference terminals; and
sending, by the representative, the input sound signals in one of the plurality of areas to the allocation server via a network; and
allocating the input sound signal of at least one of the conference terminals in a first area among the areas to at least one of the conference terminals in a second area among the areas to be played, wherein the first area is different from the second area, and the input sound signal obtained from picking up the sound by the at least one of the conference terminals in each of the areas is not played by any one of the conference terminals in the same area.

2. The multi-device coordinating method for a conference as described in claim 1, wherein the step of obtaining the input sound signals from picking up the sound by the conference terminals in each of the areas comprises:
separating an individual sound signal recorded from a speaking person corresponding to each of the conference terminals from the input sound signal, wherein the individual sound signal of each of the speaking persons is allocated to the at least one of the conference terminals in a different area to be played.

3. The multi-device coordinating method for a conference as described in claim 2, wherein the step of separating the individual sound signal recorded from the speaking person corresponding to each of the conference terminals from the input sound signal comprises:
cancelling an echo in the input sound signal obtained from picking up the sound by the sound receiver of a conference terminal among the conference terminals in the first area according to an output sound signal played by the loudspeaker of the at least one of the conference terminals in the first area.

4. The multi-device coordinating method for a conference as described in claim 2, wherein the step of separating the individual sound signal recorded from the speaking person corresponding to each of the conference terminals from the input sound signal comprises:
separating the individual sound signal recorded from the speaking person corresponding to a second conference terminal in the first area with the input sound signal of a first conference terminal in the first area serving as reference noise, wherein the second conference terminal is different from the first conference terminal.

5. The multi-device coordinating method for a conference as described in claim 3, wherein the step of separating the individual sound signal recorded from the speaking person corresponding to each of the conference terminals from the input sound signal comprises:
separating the individual sound signal recorded from the speaking person corresponding to a second conference terminal in the first area with the input sound signal of a first conference terminal in the first area serving as reference noise, wherein the second conference terminal is different from the first conference terminal.

6. The multi-device coordinating method for a conference as described in claim 2, wherein the step of allocating the input sound signal of the at least one of the conference terminals in the first area among the areas to the at least one of the conference terminals in the second area among the areas to be played comprises:
synthesizing at least one of the individual sound signals of the at least one of the conference terminals in the first area to be played by the at least one of the conference terminals in the second area.

7. (canceled)

8. The multi-device coordinating method for a conference as described in claim 1, wherein the step of obtaining input sound signals from picking up the sound by the conference terminals in each of the areas comprises:
extracting the input sound signals of the conference terminals and sending the input sound signals to the representative through virtual audio cable (VAC).

9. (canceled)

10. The multi-device coordinating method for a conference as described in claim 1, wherein the step of allocating the input sound signal comprises:
allocating, by the allocation server, the input sound signals to the at least one of the conference terminals in the second area via the representative.

11. A conference terminal, comprising:
a sound receiver configured to obtain an input sound signal from picking up a sound;
a loudspeaker configured to play a sound;
a communication transceiver configured to send or receive data; and
a processor coupled to the sound receiver, the loudspeaker, and the communication transceiver, and being configured to:
determine to belong to a first area among a plurality of areas according to location relationship, wherein each of the areas comprises at least one conference terminal that is close in the location relationship;
determine the conference terminal as a representative of the first area;
obtain the input sound signals from another conference terminal in the first area;
determine the conference terminal as an allocation server;
receive, from a representative of the second area, the input sound signals in the second area via a network;
send the input sound signal through the communication transceiver; and
play the input sound signal of at least one of the conference terminals in a second area among the areas through the loudspeaker, wherein the first area is different from the second area, and the input sound signal obtained from picking up the sound by the at least one of the conference terminals in each of the areas is not played by the loudspeaker of any one of the conference terminals in the same area.

12. The conference terminal as described in claim 11, wherein the processor is further configured to:
separate an individual sound signal recorded from a speaking person corresponding to each of the conference terminals from the input sound signal, wherein the individual sound signal of each of the speaking persons is allocated to the at least one of the conference terminals in a different area to be played.

13. The conference terminal as described in claim 12, wherein the processor is further configured to:
cancel an echo in the input sound signal obtained from picking up the sound by the sound receiver of a conference terminal among the conference terminals in the first area according to an output sound signal played by the loudspeaker of the at least one of the conference terminals in the first area.

14. The conference terminal as described in claim 12, wherein the processor is further configured to:
separate the individual sound signal recorded from the speaking person corresponding to a second conference terminal in the first area with the input sound signal of a first conference terminal in the first area serving as reference noise, wherein the second conference terminal is different from the first conference terminal.

15. The conference terminal as described in claim 13, wherein the processor is further configured to:
separate the individual sound signal recorded from the speaking person corresponding to a second conference terminal in the first area with the input sound signal of a first conference terminal in the first area serving as reference noise, wherein the second conference terminal is different from the first conference terminal.

16. The conference terminal as described in claim 12, wherein the processor is further configured to:
synthesize at least one of the individual sound signals of the at least one of the conference terminals in the first area and play a synthesized sound signal through the loudspeaker.

17. (canceled)

18. The conference terminal as described in claim 11, wherein the processor is further configured to:
extract the input sound signals of the conference terminals in the first area and receive the input sound signals through virtual audio cable (VAC).

19. (canceled)

20. The conference terminal as described in claim 11, wherein the processor is further configured to:
allocate the input sound signals of the first area to the at least one of the conference terminals in the second area via the representative of the second area.
